(19) United States
(12) Patent Application Publication
(10) Pub. No.: US 2025/0104320 A1
(43) Pub. Date: Mar. 27, 2025

(54) SYSTEM AND CONTROL METHOD OF SYSTEM

(71) Applicant: CANON KABUSHIKI KAISHA, Tokyo (JP)

(72) Inventor: HIROYUKI OKAMOTO, Kanagawa (JP)

(21) Appl. No.: 18/883,986

(22) Filed: Sep. 12, 2024

(30) Foreign Application Priority Data
Sep. 25, 2023 (JP) 2023-161726

(51) Int. Cl. G06T 13/40; G06F 3/01

(52) U.S. Cl. CPC G06T 13/40; G06F 3/011

(57) ABSTRACT

A system including one or more computers includes one or more memories storing instructions, and one or more processors capable of executing the instructions causing the system to execute control of a movement of an avatar in a virtual space, wherein, as the control of the movement, restriction of a movement of an avatar based on detection data of a user corresponding to the avatar is executed according to either a movement restriction mode for restricting a movement of an avatar or an input restriction mode for restricting input from a user.

### BACKGROUND

### Field

The present relates to a system that controls the movement of an avatar in a virtual space, and a control method of the system.

### Description of the Related Art

As a collective term of techniques for creating spaces that provide simulation experience by merging an actual world and a virtual world, such as virtual reality (VR) or augmented reality (AR), extended reality/cross reality (XR) has attracted attention, and the approach to various types of standardization has been made. In recent years, virtual spaces and services that use such techniques are called metaverse, and the use of these techniques has become common not only for entertainment purposes such as games, but also in business scenes such as virtual offices and VR meeting rooms.

In a virtual space, each user wears a head mounted display (HMD) and communicates with avatars of other users in the virtual space via the HMD similarly to a real space.

By the HMD tracking the positions of the body and hands of the user, the HMD, and a controller, and gestures, the user can move an avatar (user avatar) in the virtual space in the same way as the motion of the user in the real space.

Japanese Unexamined Patent Application Publication (Translation of PCT Application) NO. 2012-521039 discusses a technique for operating a virtual object by recognizing a gesture of the user. According to Japanese Unexamined Patent Application Publication NO. 2012-521039, by detecting and analyzing the gesture of the user, it is possible to input gesture information to an application and operate the virtual object, and improve user experience in the operation of the virtual object.

Nevertheless, if the gesture of the user is always input to the application and reflected in a user avatar in the virtual space, the user avatar sometimes moves even when the user has no intention of moving the user avatar. For example, even when the user has no intention of moving a user avatar during conversation in the virtual space, if the user changes his/her posture in the actual world due to reasons such as fatigue (e.g., if the user sits down), the user avatar also sits down.

Because the above-described gesture detection sometimes includes erroneous detection, a gesture different from a gesture made by the user is sometimes input. For example, when the user raises his/her arm in the actual world in order to scratch his/her head, the movement is erroneously detected as a movement of flicking away an arm, and an arm of a user avatar sometimes slaps at a user avatar of a nearby user.

### SUMMARY

According to an aspect of the present disclosure, a system including one or more computers includes one or more memories storing instructions, and one or more processors capable of executing the instructions causing the system to execute control of a movement of an avatar in a virtual space, wherein, as the control of the movement, restriction of a movement of an avatar based on detection data of a user corresponding to the avatar is executed according to either a movement restriction mode for restricting a movement of an avatar or an input restriction mode for restricting input from a user.

Further features of the present disclosure will become apparent from the following description of exemplary embodiments with reference to the attached drawings.

### BRIEF DESCRIPTION OF THE DRAWINGS

FIG. 1 is a diagram exemplifying an overall configuration of a system according to the present exemplary embodiment.

FIG. 2 is a hardware configuration diagram of a server computer or a client terminal included in the system according to the present exemplary embodiment.

FIG. 3 is a software configuration diagram of the system according to the present exemplary embodiment.

FIG. 4A is a diagram illustrating a display screen of a client terminal according to a first exemplary embodiment.

FIG. 4B is a diagram illustrating a display screen of a client terminal according to the first exemplary embodiment.

FIG. 4C is a diagram illustrating a display screen of a client terminal according to the first exemplary embodiment.

FIG. 4D is a diagram illustrating a display screen of a client terminal according to the first exemplary embodiment.

FIG. 5 is a diagram illustrating a sequence of processing to be executed by the system according to the present exemplary embodiment.

FIGS. 6A and 6B are flowcharts illustrating control information setting processing and user avatar movement processing according to the first exemplary embodiment.

FIG. 7 is a diagram illustrating a display screen of a client terminal according to a second exemplary embodiment.

FIG. 8 is a flowchart illustrating user avatar movement processing according to the second exemplary embodiment.

FIG. 9A is a diagram illustrating a display screen of a client terminal according to a third exemplary embodiment.

FIG. 9B is a diagram illustrating a display screen of a client terminal according to the third exemplary embodiment.

FIGS. 10A and 10B are flowcharts illustrating user avatar movement processing according to the third exemplary embodiment.

### DESCRIPTION OF THE EMBODIMENTS

Hereinafter, exemplary embodiments of the present disclosure will be described with reference to the drawings.

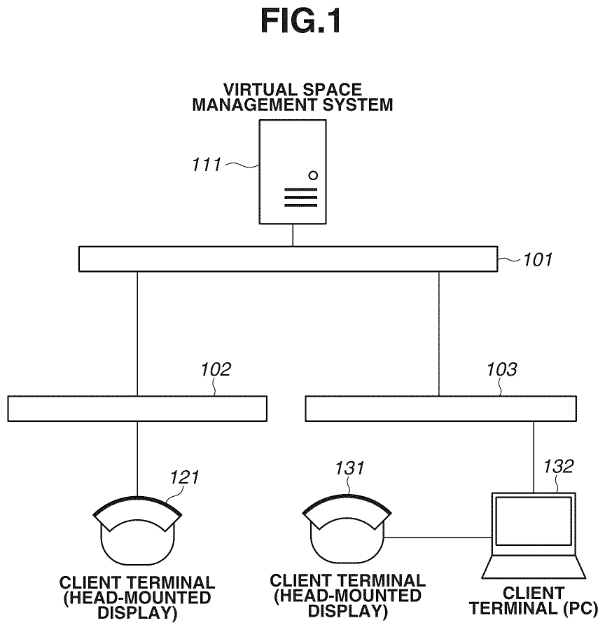

FIG. 1 is a diagram exemplifying an overall configuration of a system according to an exemplary embodiment of the present disclosure.

As illustrated in FIG. 1, in the system according to the present exemplary embodiment, a virtual space management system 111 and client terminals 121 and 132 are connected via networks 101 to 103. In addition, a client terminal 131 is connected to the client terminal 132.

The networks 101 to 103 are communication networks implemented by, for example, a local area network (LAN) such as the internet, a wide area network (WAN), a telephone line, a dedicated digital line, an asynchronous transfer mode (ATM), a frame relay line, a cable television line, and a wireless line for data broadcasting. The networks 101 to 103 are only required to be able to transmit and receive data, and may be wired or wireless networks. In the present exemplary embodiment, the network 101 is the internet, and the networks 102 and 103 are the internet or wireless LANs set as a network of a standard home or a company.

The client terminals 121 and 131 are, for example, dedicated hardware components supporting the drawing of virtual objects to be handled in extended reality/cross reality (XR), such as head-mounted displays (HMDs) or smart glasses, or mobile terminals including internal program execution environments, such as smartphones. In addition, the client terminals 121 and 131 each include a camera for capturing the images of the periphery, and a display for displaying virtual objects. By recognizing fingers of the user through the camera and overlaying a movement in a real space on a movement in a virtual space, the client terminals 121 and 131 provide simulation experience in which actual and virtual worlds are merged. In a case where the client terminals 121 and 131 are devices other than dedicated hardware components, such as smartphones, virtual objects are drawn using a web browser or an application programming interface (API) provided by an operating system (OS). In the present exemplary embodiment, the description will be given assuming that the client terminals 121 and 131 are HMDs.

The client terminal 132 is a personal computer (PC), and is an information processing apparatus including a display, such as a laptop PC, a desktop PC, or a smartphone. The HMDs may independently perform processing like the client terminal 121, or may perform processing in cooperation with a PC, like the client terminals 131 and 132.

The virtual space management system 111 is a system for providing each client terminal with a virtual object in a virtual space, an avatar simulating each user, virtual objects provided by services and applications, and movement information of these. The virtual space management system 111 also performs the management of users who use the client terminals 121, 122, and 132. That is, the virtual space management system 111 performs login/logout processing in response to a login/logout request from the client terminal 121 or 132. The virtual space management system 111 is constructed using a server computer. Alternatively, the virtual space management system 111 can be constructed by employing a cloud computing technique. Hereinafter, an avatar of a user who moves in the virtual space will be referred to as a “user avatar”.

The functions of the virtual space management system 111, which will be described in the present exemplary embodiment, may be implemented by a single server or a single virtual server, or may be implemented by a plurality of servers or a plurality of virtual servers. Alternatively, a plurality of virtual servers may be executed on a single server.

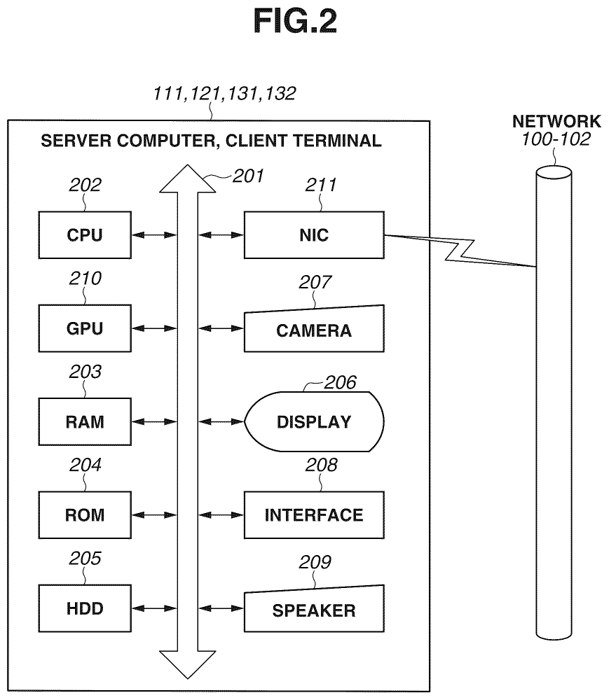

FIG. 2 is a diagram illustrating an example of a hardware configuration of the virtual space management system 111 or the client terminal 121, 131, or 132.

In FIG. 2, a central processing unit (CPU) 202 controls the entire apparatus. The CPU 202 executes an application program or an OS stored in a hard disk drive (HDD) 205, and performs the control of temporarily storing information and files necessary for the execution of programs into a random access memory (RAM) 203.

A graphics processing unit (GPU) 210 performs calculation processing necessary for drawing a virtual object or an avatar in real time. A read only memory (ROM) 204 is a storage unit, and stores various types of data such as basic input/output (I/O) programs thereinside.

The RAM 203 is a temporary storage unit, and functions as a main memory and a work area of the CPU 202 and the GPU 210.

The HDD 205 is one of external storage units, functions as a large-capacity memory, and stores application programs of a web browser, programs of a service server unit, an OS, and related programs. Another storage device such as a solid state drive (SSD) or an embedded multi-media card (eMMC) may be provided in place or together with the HDD.

A display 206 is a display unit, and displays virtual objects and information necessary for operations. The display 206 may be a device such as a touch panel that also has a function of receiving an operation instruction from the user.

The camera 207 is a rear camera of the client terminal 121 or 131 that captures videos of the periphery, or a front camera of the client terminal 121 or 131 that mainly captures the images of the user himself/herself. By analyzing the videos captured especially by the rear camera, using a program stored in the HDD 205, the camera 207 can synchronize the movement of a user in the real space and the movement of a user avatar in the virtual space. The virtual space management system 111 and the client terminal 132 not necessarily include the camera 207.

The interface 208 is an external apparatus interface (I/F), and connects peripheral devices such as various external sensors. By recognizing the movement of the user in the real space, using the above-described camera 207, a virtual object in the virtual space can be operated. Also by operating a dedicated controller connected to the interface 208, an equivalent function can be implemented as well.

A speaker 209 is a device that converts an electronic signal in the client terminal 121, 131, or 132 into physical sound, and the user can hear sound provided by the virtual space management system 111 or the client terminal 121, 131, or 132 via the speaker 209. The user may hear sound via the speaker 209, or may hear sound via an external device such as headphones that is connected to the interface 208.

A system bus 201 controls a flow of data in the apparatus.

A network interface card (NIC) 211 communicates data with an external apparatus via the networks 100 to 102.

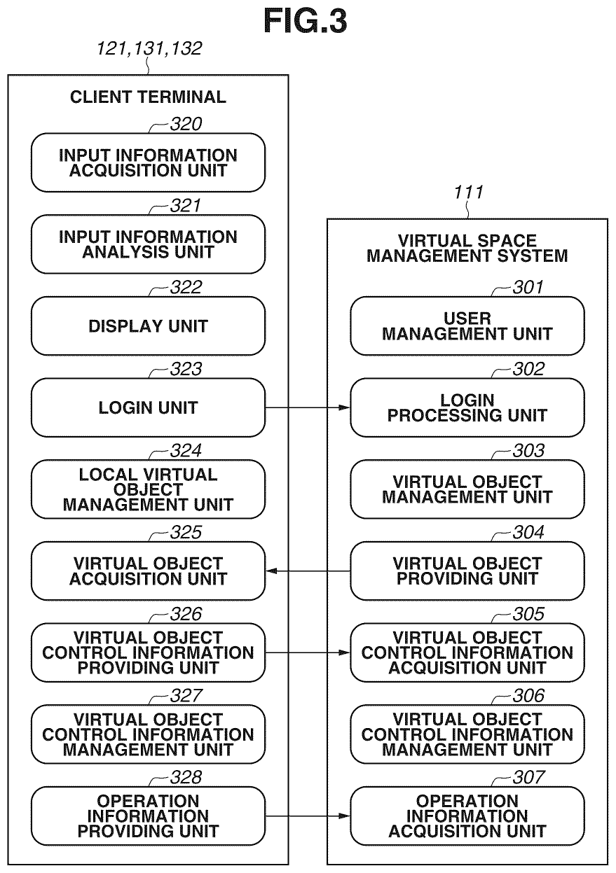

The above-described configuration of the computer is an example, and the configuration is not limited to the configuration example illustrated in FIG. 2. For example, storage destinations of data and programs can be changed to the RAM 203, the ROM 204, or the HDD 205 in accordance with their features. In addition, by the CPU 202 or the GPU 210 executing processing based on a program stored in the HDD 205, a function or processing in a software configuration as illustrated in FIG. 3 is implemented.

FIG. 3 is a diagram illustrating a software configuration of the virtual space management system 111 and the client terminal 121, 131, or 132, and specifically illustrates a software configuration selectively including functions related to the present exemplary embodiment.

The virtual space management system 111 includes a user management unit 301 and a login processing unit 302 as user management functions. As basic functions of providing a virtual space, the virtual space management system 111 also includes a virtual object management unit 303, a virtual object providing unit 304, a virtual object control information acquisition unit 305, a virtual object control information management unit 306, and an operation information acquisition unit 307.

The user management unit 301 manages user information and login information.

The login processing unit 302 receives a login request from the client terminal 121, 131, or 132, checks the login request against information in the user management unit 301, and returns a login processing result to the client terminal 121, 131, or 132.

Table 1 provided below shows an example of data to be managed by the user management unit 301.

TABLE 1
User Management Table

| | | Login | Login Expiration |
|---|---|---|---|
| User ID | Password | State | Date |
| user A | ********** | on | 2022 Dec. 31/0:00 |
| user B | ********** | on | 2022 Dec. 31/0:00 |
| user C | ********** | off | |

A user ID column indicates an ID for uniquely identifying a user. A password column indicates a password for basic authentication that is to be used when a user logs into the system using the user ID. The login processing unit 302 checks a combination of a user ID and a password that are included in a login request from the client terminal 121, 131, or 132, against Table 1, and if the combination matches any combination in Table 1, the login processing unit 302 returns a login result indicating a success, to each client terminal. A login state column indicates a login state of each user, and “on” indicates a logged in state and “off” indicates a logged out state. A login expiration date column indicates an expiration date of an authenticated state of a login user.

The virtual object management unit 303 manages a virtual object to be arranged in the virtual space and three-dimensional (3D) data of each user avatar.

The virtual object providing unit 304 provides the client terminal 121, 131, or 132 with the 3D data managed by the virtual object management unit 303.

Table 2 provided below shows an example of data of each virtual object that managed by the virtual object management unit 303.

TABLE 2
Virtual Object Management Table

| Virtual Object | | | Movement |
|---|---|---|---|
| ID | 3D Data | User | Control |
| userobjectA | ooo.obj | | false |
| user A avatar | aaa.obj | user A | true |
| user B avatar | bbb.obj | user B | true |
| user C avatar | ccc.obj | user C | false |

A virtual object ID column indicates an ID for uniquely identifying a virtual object in the virtual space. A 3D data column indicates data of a 3D model in various formats. A user column indicates which user's user avatar the virtual object corresponds to, and in a case where the user column is blank, it indicates that the virtual object is not a user avatar but a virtual object prepared by an application or the like. A movement control column indicates whether the movement of the virtual object is controlled, “true” indicates that movement control is set, and “false” indicates that movement control is not set. The details of the movement control is managed by the virtual object control information management unit 306 to be described below.

The virtual object control information acquisition unit 305 acquires control information regarding a virtual object, from the client terminal 121, 131, or 132.

The virtual object control information management unit 306 manages the control information acquired by the virtual object control information acquisition unit 305.

Table 3 provided below shows an example of data of control information regarding each virtual object managed by the virtual object control information management unit 306.

TABLE 3
Virtual Object Control Information Management Unit Table

| Virtual | |
|---|---|
| Object ID | Movement-Restricted Range |
| user A avatar | (0, 0, 0), (10, 0, 0), (0, 10, 0), (10, 10, 0), |
| | (0, 0, 10), (10, 0, 10), (0, 10, 10), (10, 10, 10), |
| user B avatar | (10, 0, 0), (20, 0, 0), (10, 10, 0), (20, 10, 0), |
| | (10, 0, 10), (20, 0, 10), (10, 10, 10), (20, 10, 10), |

The virtual object ID column is the same as that described in the description of Table 2, and virtual object IDs the movement control columns of which in Table 2 indicate “true” are managed. A movement-restricted range column indicates a range of a virtual object within which a movement is to be restricted. In Table 3, as an example, a coordinate of a 3D model of a virtual object is provided as a value, and it indicates that, within a range designated by the coordinate, a movement is not to be performed even when operation input is performed. In Table 3, as an example, ranges are designated by eight coordinates, but the number of coordinates is not limited to eight. Alternatively, the range may be designated by another method instead of coordinates.

The operation information acquisition unit 307 performs the acquisition of operation information regarding a virtual object, from the client terminal 121, 131, or 132. Collectively referring to the operation information acquired by the operation information acquisition unit 307, and the information managed by the virtual object management unit 303 and the virtual object control information management unit 306, the virtual space management system 111 determines the movement of the virtual object.

For example, a case where operation information of a virtual object whose virtual object ID is a user A avatar has been acquired will be described using Tables 2 and 3 as an example.

The virtual space management system 111 acquires information regarding the user A avatar (exemplified in Table 2), from the virtual object management unit 303. In the example in Table 2, because a movement control column of the virtual object whose virtual object ID is the user A avatar indicates “true”, and the virtual object is subject to movement control, the virtual space management system 111 acquires control information of the user A avatar (exemplified in Table 3) from the virtual object control information management unit 306. Then, based on the range of a movement-restricted range of the user A avatar included in the acquired control information and the operation information acquired by the operation information acquisition unit 307, the movement of the virtual object is determined in such a manner as to move the virtual object within a range of the virtual object that does not correspond to the movement-restricted range, and not to move the virtual object within a range of the virtual object that corresponds to the movement-restricted range.

Next, a software configuration of the client terminal 121, 131, or 132 will be described.

The client terminal 121, 131, or 132 includes an input information acquisition unit 320, an input information analysis unit 321, a display unit 322, a login unit 323, a local virtual object management unit 324, and a virtual object acquisition unit 325. The client terminal 121, 131, or 132 further includes a virtual object control information providing unit 326, a virtual object control information management unit 327, and an operation information providing unit 328.

The input information acquisition unit 320 performs the acquisition of images of fingers that have been captured by the camera 207 and information input via an input device connected to the interface 208.

The input information analysis unit 321 analyzes a user movement such as a gesture that has been acquired by the input information acquisition unit 320, and converts the user movement into input information manageable by the system or an application.

The display unit 322 displays a virtual object and a user avatar in the virtual space via the display 206.

The login unit 323 transmits a user name and a password that have been entered by the user, to the login processing unit 302. An authentication method for logging into the virtual space management system 111 may be biometric authentication such as face authentication executed using a face image captured by the camera 207, iris authentication executed using an iris, or fingerprint authentication executed using a fingerprint sensor connected to the interface 208.

The local virtual object management unit 324 manages, on the client terminal 121, 131, or 132, 3D data of a virtual object or a user avatar, and information regarding the movement of the 3D data, which have been acquired from the virtual space management system 111.

The virtual object acquisition unit 325 acquires, from the virtual object providing unit 304, 3D data of a virtual object or a user avatar, and information regarding the movement of the 3D data, and stores these into the local virtual object management unit 324.

The virtual object control information management unit 327 manages virtual object control information entered by the user. Information to be managed here is the same as the information shown in the virtual object control information management unit table of Table 3. For example, in a case where a user A operates a client terminal, only information regarding the user A avatar, which is a user avatar of the user A, is managed.

The virtual object control information providing unit 326 transmits the information managed by the virtual object control information management unit 327, to the virtual object control information acquisition unit 305.

The operation information providing unit 328 transmits user avatar operation information that has been acquired by the input information acquisition unit 320 and analyzed by the input information analysis unit 321, to the operation information acquisition unit 307.

By the functions of the above-described components 301 to 328, it is possible to provide, in real time, the user with the movement of a virtual object or a user avatar in the virtual space provided by the virtual space management system 111. It is also possible to control the user avatar not to perform a movement unintended by the user.

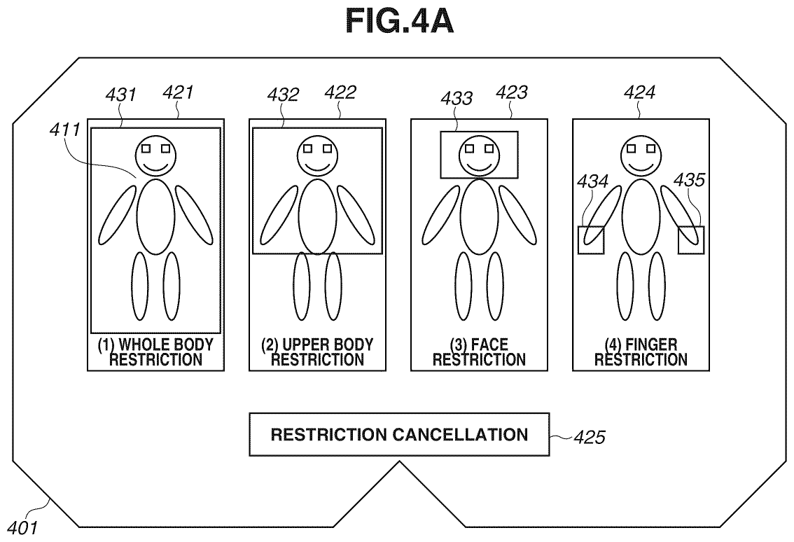

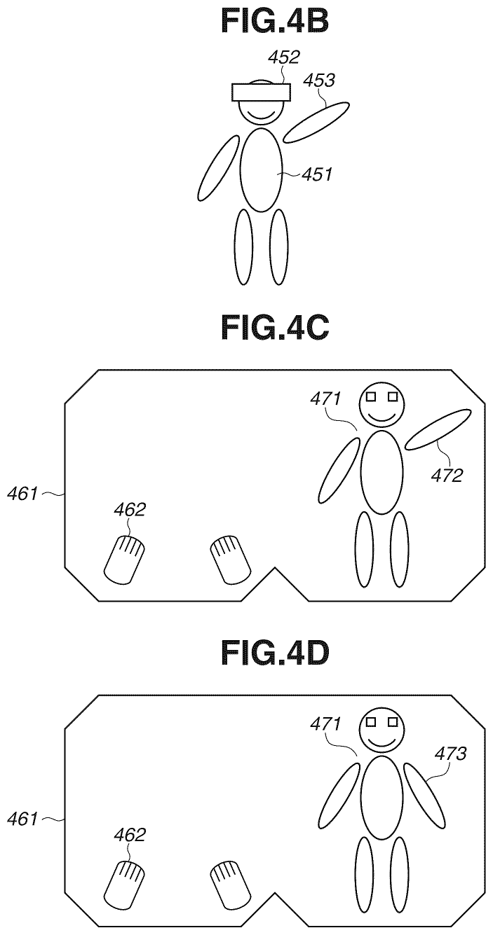

A method of controlling the movement of a user avatar in the virtual space, which is directed to by the present disclosure, will be described with reference to FIGS. 4A to 4D, 5, and 6.

FIG. 4A is a diagram illustrating an example of a video to be displayed on the display 206 of the client terminal 121 or 131, and illustrates an input user interface (UI) example for controlling the movement of a user avatar in the present exemplary embodiment.

FIGS. 4B and 4C are diagrams illustrating a gesture of a user and an example of the movement of a user avatar that is caused by the gesture, and specifically illustrate an example of the movement to be performed in a case where the user makes a gesture of raising his/her left arm.

More specifically, FIG. 4B illustrates a user in an actual world who uses the client terminal 121, and illustrates a gesture example of the user in the present exemplary embodiment.

FIGS. 4C and 4D each illustrate a video example in the virtual space that is to be displayed on the display 206 of the client terminal 131, and a movement example of a user avatar in the present exemplary embodiment. FIG. 4C corresponds to an example of a movement to be performed in a case where movement control is not set, and FIG. 4D corresponds to an example of a movement to be performed in a case where movement control is set.

In the present exemplary embodiment, a user who operates the client terminal 121 is assumed to be the user whose user ID in the user ID column in Tables 1 and 2 described above is the user A. FIG. 4A illustrates a video displayed on the display 206 of the client terminal 121 of the user A, and FIG. 4B illustrates the user whose user ID is the user A. On the other hand, a user who operates the client terminal 131 or 132 is assumed to be a user whose user ID in the user ID column in Tables 1 and 2 described above is a user B. FIGS. 4C and 4D each illustrate a video displayed on the display 206 of the client terminal 131 of the user B.

First of all, FIG. 4A will be described.

FIG. 4A illustrates a video from a user viewpoint of the user whose user ID managed in the user management table of Table 1 is the user A, and illustrates an input UI example for controlling the movement of a user avatar in the present exemplary embodiment.

A display 401 corresponds to the display 206 of the client terminal 121 used by the user A.

A user avatar 411 is a user avatar of the user A, and managed by the virtual object management unit 303. As an example, FIG. 4A illustrates a virtual object of a user avatar whose virtual object ID in the virtual object management table of Table 2 is the user A avatar.

Selective entry forms 421 to 425 indicate patterns of controlling movements.

The selective entry forms 421 to 424 are options for restricting movements, and the selective entry form 425 is an option for cancelling movement restriction. Range display frames 431 to 435 indicate ranges within which the movement of the user avatar is to be restricted. The selective entry form 421 is an option for restricting the movement of the whole body of the user avatar, and the range display frame 431 indicates the whole body of the user avatar that has been selected as a range. The selective entry form 422 is an option for restricting the movement of the upper body of the user avatar, and the range display frame 432 indicates the upper body of the user avatar that has been selected as a range. The selective entry form 423 is an option for restricting the movement of the face of the user avatar, and the range display frame 433 indicates the face of the user avatar that has been selected as a range. The selective entry form 424 is an option for restricting the movement of the fingers of the user avatar, and the range display frames 434 and 435 indicate the fingers of the user avatar that have been selected as ranges. By selecting the selective entry forms 421 to 424, the user can perform the movement restriction of the avatar. By selecting the selective entry form 425, the user can also cancel the movement restriction of the avatar.

Next, FIGS. 4B and 4C will be described.

FIG. 4B illustrates a video in the actual world of the user whose user ID managed in the user management table of Table 1 is the user A, and illustrates a gesture example of the user in the present exemplary embodiment.

A user 451 corresponds to the user A in the actual world, and a client terminal 452 corresponds to the client terminal 121. FIG. 4B illustrates a state in which the user A is using the client terminal 121. A left arm 453 indicates a left arm of the user A, and FIG. 4B illustrates a state in which the user A is performing the gesture of raising the left arm.

FIG. 4C illustrates a video of the user A avatar in the virtual space that is viewed from a user viewpoint of the user whose user ID managed in the user management table of Table 1 is the user B, and illustrates a video to be displayed in a case where movement control is not set for the user A avatar.

A display 461 corresponds to the display 206 of the client terminal 131 used by the user B.

Fingers 462 are fingers of the user avatar of the user B, and indicate a virtual object whose virtual object ID in the virtual object management table of Table 2 is a user B avatar.

A virtual object 471 indicates a virtual object of the user avatar of the user A, and a left arm 472 indicates a left arm of the user avatar of the user A. Because FIG. 4C illustrates the case where movement control is not set, the left arm 472 of the user avatar is also raised similarly to the left arm 453 of the user in the actual world.

Similarly to FIG. 4C, FIG. 4D illustrates a video of the user A avatar in the virtual space that is viewed from the user viewpoint of the user B, and illustrates a video to be displayed in a case where movement control is set for the user A avatar.

The components 461, 462, and 471 are the same as those described with reference to FIG. 4C. A left arm 473 indicates a left arm of the virtual object of the user avatar of the user A. In a case where movement control such as whole body restriction or upper body restriction is set using the selective entry form 421 or 422, because the left arm of the user avatar falls within a restricted range, even when the left arm 453 of the user in the actual world is raised, the left arm 473 of the user avatar is not raised and not moved.

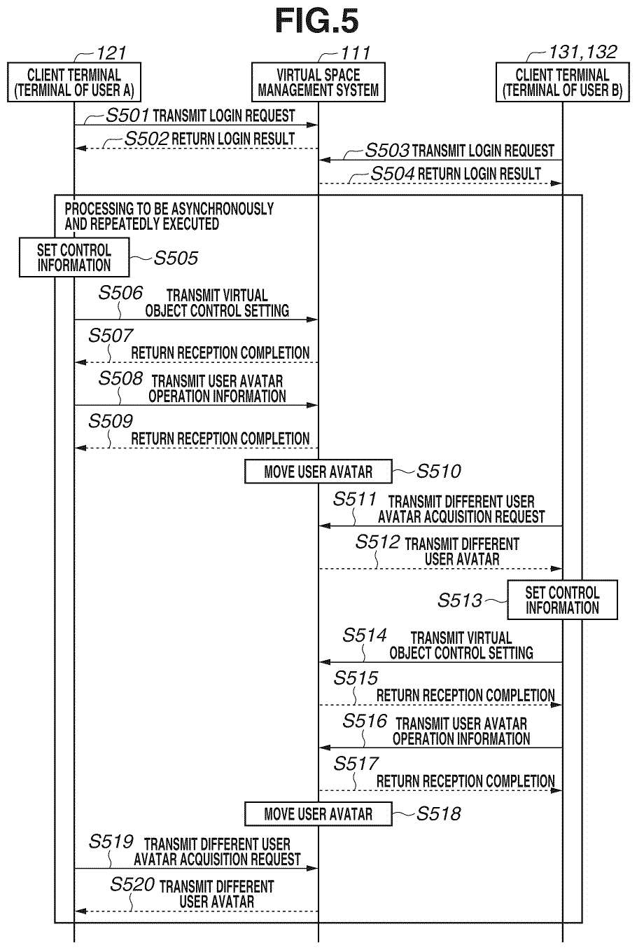

Next, the entire processing sequence will be described with reference to FIG. 5.

FIG. 5 is a diagram illustrating an example of a sequence up to processing in which a user controls the movement of a user avatar or cancels the control, and shares the movement of the user avatar with a different user. The processing illustrated in FIG. 5 that is to be executed by the client terminal 121 is executed by the software configuration of the client terminal 121 illustrated in FIG. 3. The processing to be executed by the virtual space management system 111 is executed by the software configuration of the virtual space management system 111 illustrated in FIG. 3. The processing to be executed by the client terminal 131 or 132 is executed by the software configuration of the client terminal 131 or 132 illustrated in FIG. 3.

In step S501, the login unit 323 of the client terminal 121 of the user A transmits a user ID and a password to the login processing unit 302.

In step S502, the login processing unit 302 checks whether the user ID and the password match the user ID and the password of the user A, by referring to the user management table of Table 1 managed by the user management unit 301, and if the user ID and the password match the user ID and the password of the user A, the login processing unit 302 returns a login result indicating a login success.

In a similar manner, in step S503, the login unit 323 of the client terminal 131 or 132 of the user B transmits a user ID and a password to the login processing unit 302.

In step S504, the login processing unit 302 checks whether the managed user ID and the password match the user ID and the password of the user B, by referring to the user management table of Table 1 managed by the user management unit 301, and if the user ID and the password match the user ID and the password of the user B, the login processing unit 302 returns a login result indicating a login success.

After that, in steps S505 to S520, steps related to the setting of virtual object movement control illustrated in FIGS. 4A to 4D, the operation of the user avatar, the movement of the user avatar, and the sharing of the user avatar are executed, and these steps are regularly executed asynchronously with other steps.

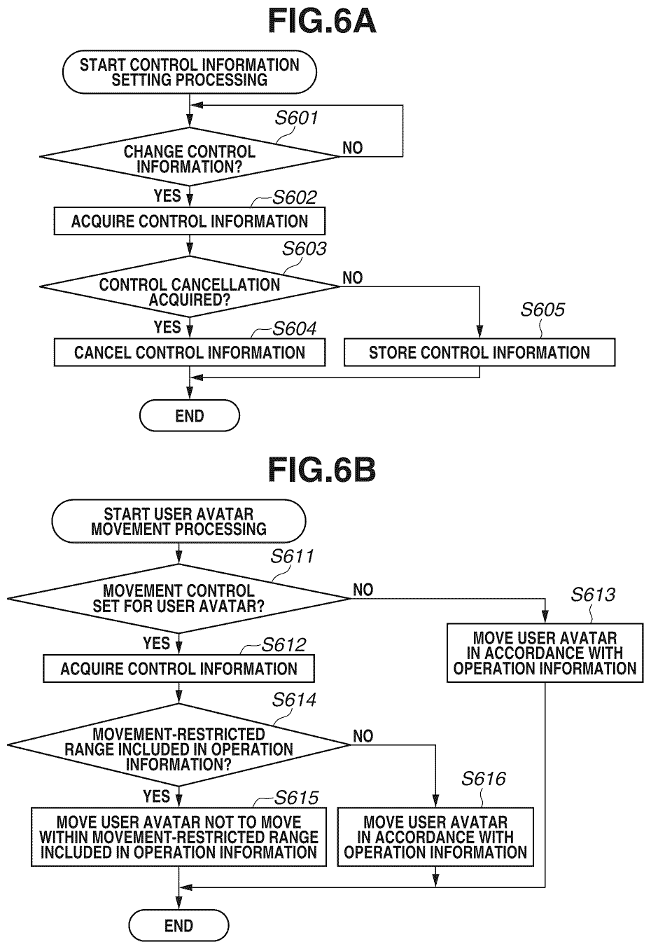

In step S505, the virtual object control information management unit 327 of the client terminal 121 of the user A sets control information of the virtual object. Specific processing to be executed in step S505 will be described with reference to a flowchart in FIG. 6A.

FIG. 6A is a flowchart illustrating an example of control information setting processing to be executed by the software configuration of the client terminal 121 illustrated in FIG. 3.

In step S601, the input information acquisition unit 320 and the input information analysis unit 321 determine whether a control information change request has been acquired from the user. In a case where the control information change request has been acquired (YES in step S601), the processing proceeds to step S602.

In step S602, the input information acquisition unit 320 acquires control information entered by the user. The control information change request may be a change request issued by the user, or may be a change request issued by the system or an application.

Next, in step S603, the input information analysis unit 321 checks whether the above-described control information acquired in step S602 is control cancellation information. In a case where the above-described control information acquired in step S602 is the control cancellation information (YES in step S603), the input information analysis unit 321 advances the processing to step S604.

In step S604, the input information analysis unit 321 deletes the control information already stored in the virtual object control information management unit 327, and ends the processing of this flowchart.

On the other hand, in a case where the above-described control information acquired in step S602 is not the control cancellation information (NO in step S603), the input information analysis unit 321 advances the processing to step S605.

In step S605, the input information analysis unit 321 stores the above-described control information acquired in step S602, into the virtual object control information management unit 327, and ends the processing of this flowchart.

Hereinafter, the description will return to the description of the flowchart in FIG. 5.

Next, in step S506, the virtual object control information providing unit 326 of the client terminal 121 of the user A transmits the control information stored in the virtual object control information management unit 327, to the virtual object control information acquisition unit 305.

In step S507, if the virtual object control information acquisition unit 305 receives the above-described control information, the virtual object control information acquisition unit 305 returns reception completion to the virtual object control information providing unit 326.

In step S508, the operation information providing unit 328 of the client terminal 121 of the user A transmits user avatar operation information from the user that has been acquired by the input information acquisition unit 320 and the input information analysis unit 321, to the operation information acquisition unit 307.

In step S509, if the operation information acquisition unit 307 receives the above-described user avatar operation information, the operation information acquisition unit 307 returns reception completion to the operation information providing unit 328.

Next, in step S510, based on the above-described virtual object control setting received in step S506 and the above-described user avatar operation information received in step S508, the virtual object management unit 303 moves the user avatar. Specific processing to be executed in step S510 will be described with reference to a flowchart in FIG. 6B.

FIG. 6B is a flowchart illustrating an example of user avatar movement processing to be executed by the software configuration of the virtual space management system 111 illustrated in FIG. 3.

In step S611, the virtual object management unit 303, based on the Virtual Object Management Table (Table 2), determines whether movement control is set for information regarding a user avatar to be operated that is included in the above-described user avatar operation information received by the operation information acquisition unit 307 in step S508.

In a case where movement control is not set for the user avatar (NO in step S611), the virtual object management unit 303 advances the processing to step S613.

In step S613, because movement control is not set for the user avatar, the virtual object management unit 303 moves the user avatar in accordance with the above-described user avatar operation information received by the operation information acquisition unit 307 in step S508. Then, the virtual object management unit 303 ends the processing of this flowchart.

On the other hand, in a case where movement control is set for the user avatar (YES in step S611), the virtual object management unit 303 advances the processing to step S612.

In step S612, the virtual object management unit 303 acquires movement control information set for the user avatar, from the virtual object control information management unit 306.

Next, in step S614, the virtual object management unit 303 determines whether a movement-restricted range in the above-described movement control information acquired in step S612 is included in the above-described user avatar operation information received by the operation information acquisition unit 307 in step S508.

In a case where the movement-restricted range in the above-described movement control information acquired in step S612 is included in the above-described user avatar operation information received by the operation information acquisition unit 307 in step S508 (YES in step S614), the virtual object management unit 303 advances the processing to step S615.

In step S615, the virtual object management unit 303 does not move the user avatar within the movement-restricted range in the above-described movement control information acquired in step S612, which is included in the above-described user avatar operation information received by the operation information acquisition unit 307 in step S508, and moves the user avatar in accordance with the user avatar operation information on the outside the movement-restricted range. Then, the virtual object management unit 303 ends the processing of this flowchart.

On the other hand, in a case where the movement-restricted range in the above-described movement control information acquired in step S612 is not included in the above-described user avatar operation information received by the operation information acquisition unit 307 in step S508 (NO in step S614), the virtual object management unit 303 advances the processing to step S616.

In step S616, the virtual object management unit 303 moves the user avatar in accordance with the user avatar operation information. Then, the virtual object management unit 303 ends the processing of this flowchart.

Hereinafter, the description will return to the description of the flowchart in FIG. 5.

In step S511, the virtual object acquisition unit 325 of the client terminal 131 or 132 of the user B transmits a user avatar (virtual object) acquisition request to the virtual object providing unit 304.

In step S512, if the virtual object providing unit 304 receives the above-described user avatar acquisition request, the virtual object providing unit 304 transmits a virtual object to the virtual object acquisition unit 325. The virtual object acquisition unit 325 thereby acquires the virtual object.

In step S513, the virtual object control information management unit 327 of the client terminal 131 or 132 of the user B sets control information of the virtual object. Because the processing in step S513 is similar to the processing in step S505, the description will be omitted.

In step S514, the virtual object control information providing unit 326 of the client terminal 131 or 132 of the user B transmits the control information stored in the virtual object control information management unit 327, to the virtual object control information acquisition unit 305.

In step S515, if the virtual object control information acquisition unit 305 receives the above-described control information, the virtual object control information acquisition unit 305 returns reception completion to the virtual object control information providing unit 326.

In step S516, the operation information providing unit 328 of the client terminal 131 or 132 of the user B transmits user avatar operation information from the user that has been acquired by the input information acquisition unit 320 and the input information analysis unit 321, to the operation information acquisition unit 307.

In step S517, if the operation information acquisition unit 307 receives the above-described user avatar operation information, the operation information acquisition unit 307 returns reception completion to the operation information providing unit 328.

Next, in step S518, based on the above-described virtual object control setting received in step S514, and the above-described user avatar operation information received in step S516, the virtual object management unit 303 moves the user avatar. Because the processing in step S518 is similar to the processing in step S510, the description will be omitted.

In step S519, the virtual object acquisition unit 325 of the client terminal 121 of the user A transmits a user avatar (virtual object) acquisition request to the virtual object providing unit 304.

In step S520, if the virtual object providing unit 304 receives the above-described user avatar acquisition request, the virtual object providing unit 304 transmits a virtual object to the virtual object acquisition unit 325. The virtual object acquisition unit 325 thereby acquires the virtual object.

As described above, in the first exemplary embodiment, the method of setting movement control of a user avatar in the virtual space, and the method of sharing the movement of the user avatar the movement of which is controlled, with a different user have been described. Using this method, it becomes possible to control the user avatar not to move or a part of the user avatar not to move when the movement is undesired by the user, and perform communication with a different user avatar.

In the first exemplary embodiment, the method of performing movement control by setting a movement-restricted range for a virtual object as shown in the virtual object control information management unit table of Table 3 has been described. Alternatively, a method of performing movement control by setting an input-restricted range for the user instead of setting a movement-restricted range for a virtual object is also conceivable.

In a second exemplary embodiment, a method of performing movement control by setting an input-restricted range for the user will be described.

Table 4 provided below shows an example of data of each virtual object managed by a virtual object management unit 303 according to the second exemplary embodiment.

TABLE 4
Virtual Object Management Table

| Virtual Object | | | Input |
|---|---|---|---|
| ID | 3D Data | User | Control |
| object A | ooo.obj | | |
| user A avatar | aaa.obj | user A | true |
| user B avatar | bbb.obj | user B | true |
| user C avatar | ccc.obj | user C | false |

A virtual object ID column, a 3D data column, and a user column are the same as those described in the description of Table 2.

An input control column indicates whether the input of the user who operates a virtual object is controlled, “true” indicates that input control is set, and “false” indicates that input control is not set. The details of the input control are managed by a virtual object control information management unit 306 according to the second exemplary embodiment, which will be described below.

Table 5 provided below shows an example of data of control information for each virtual object managed by the virtual object control information management unit 306 according to the second exemplary embodiment.

TABLE 5
Virtual Object Control Information Management Unit Table

| User ID | Input-Restricted Range |
|---|---|
| user A | Whole Body |
| user B | Upper Body |

A user ID column is the same as that described in the description of Table 1, and indicates user IDs for which movement control is set. An input-restricted range column indicates the range of the body of the user in which input is to be restricted.

In Table 5, as an example, a body region of the user is provided as a value, and this indicates that a virtual object is not to be moved even when operation input is performed in the body region. In Table 5, as an example, an input-restricted range is designated by a body region, but the input-restricted range may be designated by a coordinate of a body as in Table 3. Alternatively, the input-restricted range may be designated by another method.

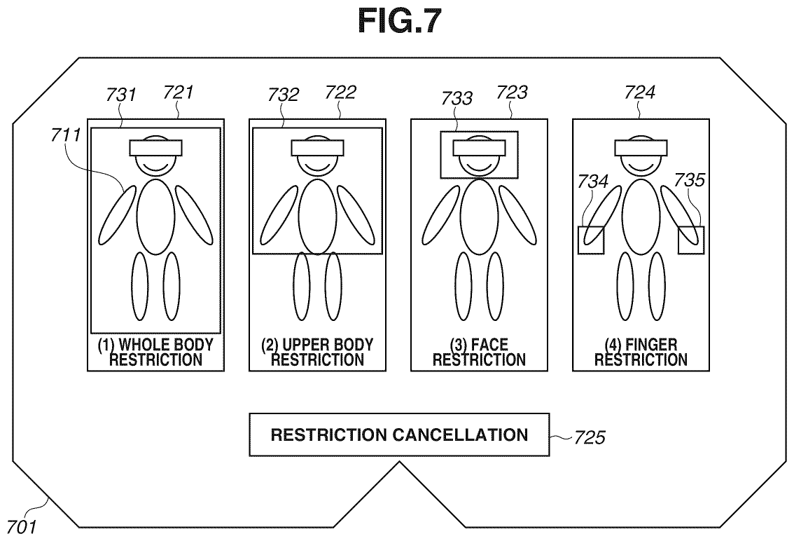

A method of performing movement control by setting an input-restricted range for the user in the second exemplary embodiment will be described with reference to FIG. 7 in addition to the drawings used in the first exemplary embodiment.

FIG. 7 is a diagram illustrating an input UI example for controlling the movement of a user avatar in the second exemplary embodiment, and specifically illustrates a video from a user viewpoint of a user whose user ID managed in the user management table of Table 1 is the user A.

A display 701 corresponds to the display 206 of the client terminal 121 used by the user A.

A user 711 corresponds to a user in the actual world.

Selective entry forms 721 to 725 indicate patterns of controlling movements, the selective entry forms 721 to 724 are options for restricting input, and the selective entry form 725 is an option for cancelling movement restriction.

Range display frames 731 to 735 indicate ranges within which the input of the user is to be restricted.

The selective entry form 721 is an option for restricting the input from the whole body of the user, and the range display frame 731 indicates the whole body of the user that has been selected as a range. The selective entry form 722 is an option for restricting the input from the upper body of the user, and the range display frame 732 indicates the upper body of the user that has been selected as a range. The selective entry form 723 is an option for restricting the input from the face of the user, and the range display frame 733 indicates the face of the user that has been selected as a range. The selective entry form 724 is an option for restricting the input from the fingers of the user, and the range display frames 734 and 735 indicate the fingers of the user that have been selected as ranges. By selecting the selective entry forms 721 to 724, the user can perform the restriction of input from the user. By selecting the selective entry form 725, the user can cancel the restriction of input from the user.

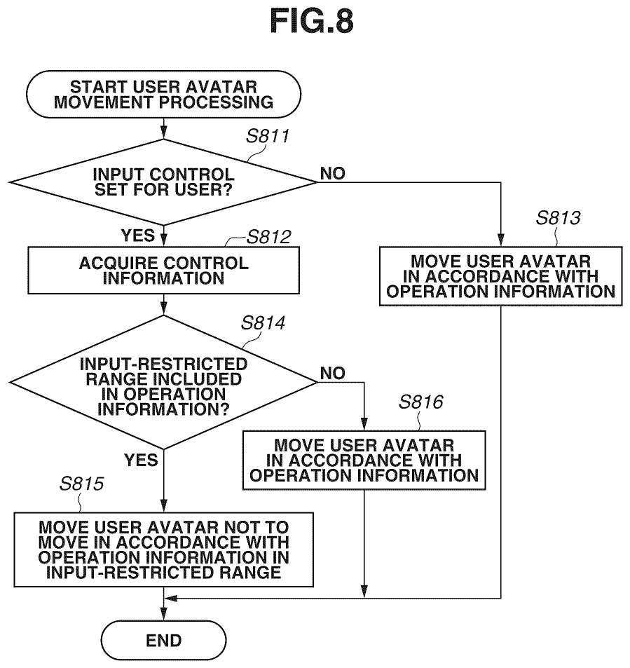

Next, the entire processing sequence will be described with reference to FIGS. 5 and 8.

The entire processing sequence in the second exemplary embodiment is similar to that in the first exemplary embodiment, but differs in processing in steps S510 and S518 in which the virtual object management unit 303 moves a user avatar. Specific processing to be executed in step S510 in the second exemplary embodiment will be described with reference to a flowchart in FIG. 8.

FIG. 8 is a flowchart illustrating an example of user avatar movement processing according to the second exemplary embodiment. The processing in this flowchart is executed by the software configuration of the virtual space management system 111 illustrated in FIG. 3.

In step S811, the virtual object management unit 303, based on the Virtual Object Management Table (Table 4), determines whether input control is set for information regarding a user avatar to be operated that is included in the user avatar operation information received by the operation information acquisition unit 307 in step S508 of FIG. 5.

In a case where input control is not set for the user who performs an operation (NO in step S811), the virtual object management unit 303 advances the processing to step S813.

In step S813, because input control is not set for the user, the virtual object management unit 303 moves the user avatar in accordance with the above-described user avatar operation information received by the operation information acquisition unit 307 in step S508. Then, the virtual object management unit 303 ends the processing of this flowchart.

On the other hand, in a case where input control is set for the user who performs an operation (YES in step S811), the virtual object management unit 303 advances the processing to step S814.

In step S814, the virtual object management unit 303 determines whether an input-restricted range in the above-described input control information acquired in step S812 is included in the above-described user avatar operation information received by the operation information acquisition unit 307 in step S508.

In a case where the input-restricted range in the above-described input control information acquired in step S812 is included in the above-described user avatar operation information received by the operation information acquisition unit 307 in step S508 (YES in step S814), the virtual object management unit 303 advances the processing to step S815.

In step S815, the virtual object management unit 303 does not move the user avatar in accordance with operation information in the input-restricted range in the above-described input control information acquired in step S812, which is included in the above-described user avatar operation information received by the operation information acquisition unit 307 in step S508, and moves the user avatar in accordance with the operation information that falls outside the input-restricted range. Then, the virtual object management unit 303 ends the processing of this flowchart.

On the other hand, in a case where the input-restricted range in the above-described input control information acquired in step S812 is not included in the above-described user avatar operation information received by the operation information acquisition unit 307 in step S508 (NO in step S814), the virtual object management unit 303 advances the processing to step S816.

In step S816, the virtual object management unit 303 moves the user avatar in accordance with the user avatar operation information. Then, the virtual object management unit 303 ends the processing of this flowchart.

Because the processing in step S518 in the second exemplary embodiment is similar to the above-described processing in step S510, the description will be omitted.

As described above, by setting an input-restricted range for the user, it is possible to perform movement control of the user avatar based on the input-restricted range. With this configuration, it becomes possible to control the user avatar not to move or a part of the user avatar not to move when the movement is undesired by the user, and perform communication with a different user avatar.

In the above-described first and second exemplary embodiments, the method of setting a movement-restricted range or an input-restricted range, and controlling a user avatar based on such a range has been described. Instead of such ranges, a movement in a specific shape is sometimes desired to be restricted. For example, it is considered that a hand sign of pointing an index finger up for performing input to the system is desired not to be reflected in a user avatar, or a user avatar is desired to avoid taking a pose that might be found inappropriate in terms of manner, such as first pump.

In a third exemplary embodiment, a method of performing movement control in such a manner as to restrict a movement in a specific shape will be described. In particular, the case of performing movement restriction of a virtual object as in the first exemplary embodiment, and the case of restricting input from the user as in the second exemplary embodiment will be individually described.

First, the case of performing movement restriction of a virtual object as in the first exemplary embodiment will be described.

Table 6 provided below shows an example of data of control information for each virtual object managed by the virtual object management unit 303 according to the third exemplary embodiment in a case where movement restriction is performed for a virtual object.

TABLE 6
Virtual Object Control Information Management Unit Table

| Virtual | |
|---|---|
| Object ID | Movement-Restricted Shape |
| user A | a(0-10, 0-10, 0-10), b(10-20, 0-10, 0-10), |
| avatar | c(0-10, 10-20, 0-10), d(10-20, 10-20, 0-10), |
| | e(0-10, 0-10, 10-20), f(10-20, 0-20, 10-20), |
| user B | a(10, 0, 0), b(20, 0, 0), c(10, 10, 0), d(20, 10, 0), |
| avatar | e(10, 0, 10), f(20, 0, 10) |

A virtual object ID column is the same as that described in the description of Table 3.

A movement-restricted shape column indicates a shape of a virtual object in which a movement is to be restricted. In Table 6, as an example, points of a 3D model of a virtual object and coordinate ranges of the points are provided as values, a combination of points of the 3D model and the coordinates corresponds to values in a movement-restricted shape column, and it indicates that, in a case where a virtual object has a specific shape, the virtual object is not to be moved. In Table 6, as an example, six points and six coordinate ranges designate a movement-restricted shape, but the number of points and the number of coordinate ranges need not be six. The shape may be designated by another method instead of designating the shape by points and coordinate ranges.

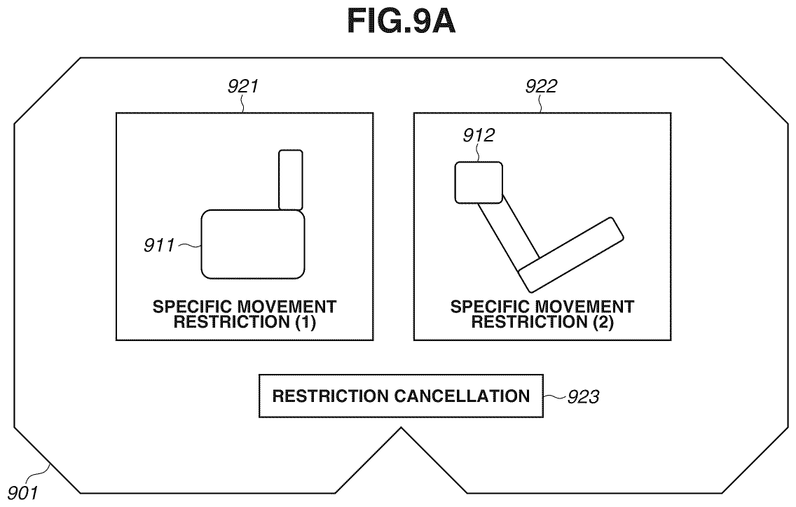

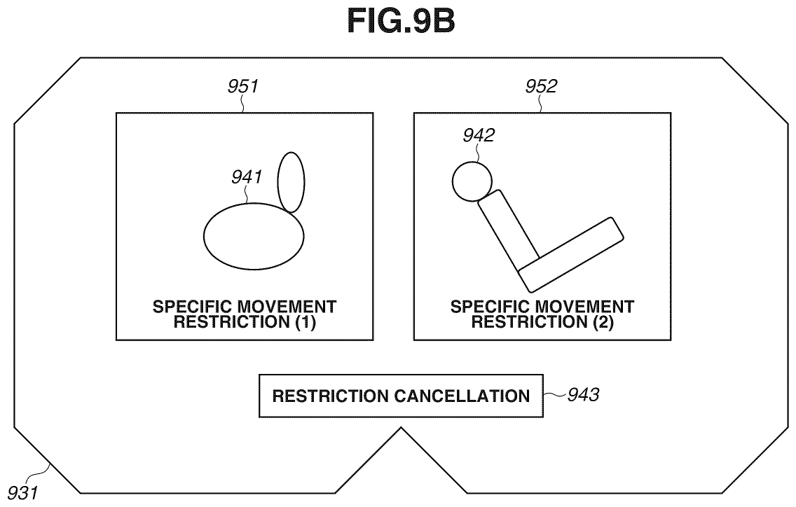

FIG. 9A is a diagram illustrating an input UI example for controlling the movement of a user avatar in a case where movement restriction is performed for a virtual object in the third exemplary embodiment, and illustrates a video from a user viewpoint of a user whose user ID managed in the user management table of Table 1 is the user A.

A display 901 corresponds to the display 206 of the client terminal 121 used by the user A.

A hand 911 indicates a hand of a user avatar of the user A managed by the virtual object management unit 303, and indicates a shape of pointing an index finger up.

An arm 912 indicates an arm of a user avatar of the user A managed by the virtual object management unit 303, and indicates a shape of pumping his/her fist.

Selective entry forms 921 to 923 indicate patterns of controlling movements, the selective entry forms 921 and 922 are options for restricting movements, and the selective entry form 923 is an option for cancelling movement control. By selecting the selective entry forms 921 or 922, the user can restrict the movement of the avatar that has a specific shape. By selecting the selective entry form 923, the user can cancel the movement restriction of the avatar.

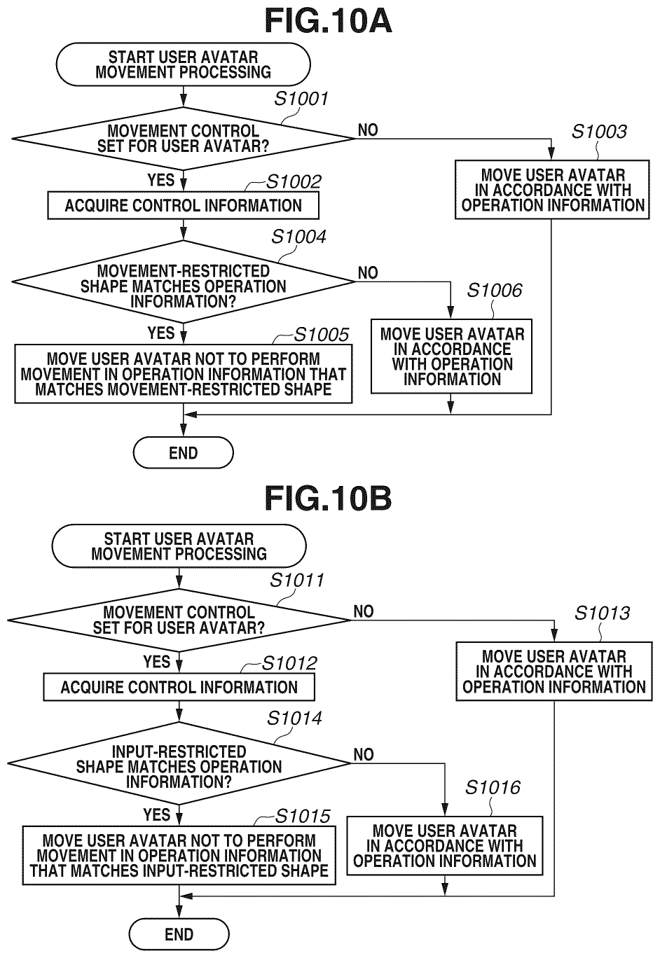

The entire processing sequence in the third exemplary embodiment is similar to that in the first exemplary embodiment, but differs in processing in steps S510 and S518 in which the virtual object management unit 303 moves a user avatar. Specific processing to be executed in step S510 in the third exemplary embodiment will be described with reference to a flowchart in FIG. 10A.

FIG. 10A is a flowchart illustrating an example of user avatar movement processing to be executed in a case where movement restriction is performed for a virtual object in the third exemplary embodiment. The processing in this flowchart is executed by the software configuration of the virtual space management system 111 illustrated in FIG. 3.

In step S1001, the virtual object management unit 303 determines whether movement control is set for information regarding a user avatar to be operated that is included in the user avatar operation information received by the operation information acquisition unit 307 in step S508 of FIG. 5.

In a case where movement control is not set for the user avatar (NO in step S1001), the virtual object management unit 303 advances the processing to step S1003.

In step S1003, because movement control is not set for the user avatar, the virtual object management unit 303 moves the user avatar in accordance with the above-described user avatar operation information received by the operation information acquisition unit 307 in step S508. Then, the virtual object management unit 303 ends the processing of this flowchart.

On the other hand, in a case where movement control is set for the user avatar (YES in step S1001), the virtual object management unit 303 advances the processing to step S1002.

In step S1002, the virtual object management unit 303 acquires movement control information set for the user avatar, from the virtual object control information management unit 306.

Next, in step S1004, the virtual object management unit 303 determines whether a movement-restricted shape in the above-described movement control information acquired in step S1002 matches or partially matches the above-described user avatar operation information received by the operation information acquisition unit 307 in step S508.

In a case where the movement-restricted shape in the above-described movement control information acquired in step S1002 matches or partially matches the above-described user avatar operation information received by the operation information acquisition unit 307 in step S508 (YES in step S1004), the virtual object management unit 303 advances the processing to step S1005.

In step S1005, the virtual object management unit 303 does not cause the user avatar to perform a movement in a shape matching or partially matching the movement-restricted shape in the above-described movement control information acquired in step S1002, which is included in the above-described user avatar operation information received by the operation information acquisition unit 307 in step S508, and moves the user avatar in accordance with the user avatar operation information as for a movement in a shape not matching the movement-restricted shape. Then, the virtual object management unit 303 ends the processing of this flowchart.

On the other hand, in a case where the movement-restricted shape in the above-described movement control information acquired in step S1002 does not match or partially match the above-described user avatar operation information received by the operation information acquisition unit 307 in step S508 (NO in step S1004), the virtual object management unit 303 advances the processing to step S1006.

In step S1006, the virtual object management unit 303 moves the user avatar in accordance with the user avatar operation information. Then, the virtual object management unit 303 ends the processing of this flowchart.

Because the processing in step S518 in the third exemplary embodiment is similar to the above-described processing in step S510, the description will be omitted.

Next, the case of restricting input from the user as in the second exemplary embodiment will be described.

Table 7 provided below shows an example of data of control information for each virtual object managed by the virtual object management unit 303 according to the third exemplary embodiment in a case where input from the user is restricted.

TABLE 7
Virtual Object Control Information Management Unit Table

| User ID | Input-Restricted Shape |
|---|---|
| user A | aaa.obj |
| user B | bbb.obj |

A user ID column is the same as that described in the description of Table 1, and indicates user IDs for which movement control is set.

An input-restricted shape column indicates a shape for which input is to be restricted. In Table 7, as an example, data of 3D model in various formats is provided as a value, and it indicates that, in a case where the body of the user or a part of the body matches or partially matches an input-restricted shape, the user avatar is not to be moved in accordance with the operation input. In Table 7, as an example, an input-restricted shape is designated by 3D model data, but the input-restricted shape may be designated by another method.

FIG. 9B is a diagram illustrating an input UI example for controlling the movement of a user avatar in a case where input from the user is restricted in the third exemplary embodiment, and illustrates a video from a user viewpoint of a user whose user ID managed in the user management table of Table 1 is the user A.

A display 931 corresponds to the display 206 of the client terminal 121 used by the user A.

A hand 941 indicates a hand of a user in the actual world, and indicates a shape of pointing an index finger up.

An arm 942 indicates an arm of a user in the actual world, and indicates a shape of pumping his/her fist.

Selective entry forms 951, 952, and 943 indicate patterns of controlling movements, the selective entry forms 951 and 952 are options for restricting input, and the selective entry form 943 is an option for cancelling movement control. By selecting the selective entry forms 951 or 952, the user can restrict the input from a specific shape of the user. By selecting the selective entry form 943, the user can cancel the restriction of input from the user. The options for restricting input are not limited to these, and any user movements and poses detectable by various sensors included in the client terminal (or connectable to the interface 208) can be used as options. Alternatively, the image of a movement or a pose of the user in the actual world may be captured using the camera 207, and the image capturing data may be registerable in the virtual space management system 111 as data for input restriction. In the virtual space management system 111, control for movement restriction of a user avatar may be executed by comparing the data for input restriction that has been registered by the user with user avatar operation information and performing similarity determination using artificial intelligence (AI).

Also in the case of restricting input from the user, the entire processing sequence in the third exemplary embodiment is similar to that in the first exemplary embodiment, but differs in processing in steps S510 and S518 in which the virtual object management unit 303 moves a user avatar. Specific processing to be executed in step S510 in the third exemplary embodiment will be described with reference to a flowchart in FIG. 10B.

FIG. 10B is a flowchart illustrating an example of user avatar movement processing to be executed in a case where input from the user is restricted in the third exemplary embodiment. The processing in this flowchart is executed by the software configuration of the virtual space management system 111 illustrated in FIG. 3.

In step S1011, the virtual object management unit 303, based on the Virtual Object Management Table (Table 4), determines whether input control is set for information regarding a user avatar to be operated that is included in the user avatar operation information received by the operation information acquisition unit 307 in step S508 of FIG. 5.

In a case where input control is not set for the user who performs an operation (NO in step S1011), the virtual object management unit 303 advances the processing to step S1013.

In step S1013, because input control is not set for the user, the virtual object management unit 303 moves the user avatar in accordance with the above-described user avatar operation information received by the operation information acquisition unit 307 in step S508. Then, the virtual object management unit 303 ends the processing of this flowchart.

On the other hand, in a case where input control is set for the user who performs an operation (YES in step S1011), the virtual object management unit 303 advances the processing to step S1014.

In step S1014, the virtual object management unit 303 determines whether an input-restricted shape in the above-described input control information acquired in step S1012 matches or partially matches the above-described user avatar operation information received by the operation information acquisition unit 307 in step S508.

In a case where the input-restricted shape in the above-described input control information acquired in step S1012 matches or partially matches the above-described user avatar operation information received by the operation information acquisition unit 307 in step S508 (YES in step S1014), the virtual object management unit 303 advances the processing to step S1015.

In step S1015, the virtual object management unit 303 does not move the user avatar in accordance with operation information in the above-described user avatar operation information received by the operation information acquisition unit 307 in step S508, which matches or partially matches the input-restricted shape in the above-described input control information acquired in step S1012, and moves the user avatar in accordance with operation information not matching the input-restricted shape. Then, the virtual object management unit 303 ends the processing of this flowchart.

On the other hand, in a case where the input-restricted shape in the above-described input control information acquired in step S1012 does not match or partially match the above-described user avatar operation information received by the operation information acquisition unit 307 in step S508 (NO in step S1014), the virtual object management unit 303 advances the processing to step S1016.

In step S1016, the virtual object management unit 303 moves the user avatar in accordance with the user avatar operation information. Then, the virtual object management unit 303 ends the processing of this flowchart.

Because the processing in step S518 in the third exemplary embodiment is similar to the above-described processing in step S510, the description will be omitted.

As described above, by setting a specific movement-restricted shape for a virtual object, or setting a specific input-restricted shape for the user, it is possible to perform movement control in such a manner that a user avatar does not perform a specific movement. By this method, it becomes possible to control the user avatar not to perform a movement in a shape undesired by the user, and perform communication with a different user avatar.

By combining the configurations described in the above-described exemplary embodiments, in the virtual space management system 111 that performs the movement control of an avatar in the virtual space, a movement restriction mode for performing the movement restriction of a virtual object (avatar) as described in the first exemplary embodiment and the anterior half of the third exemplary embodiment, and an input restriction mode for restricting input from the user as described in the second exemplary embodiment and the posterior half of the third exemplary embodiment may be provided, and a user or an administrator may set the movement restriction mode or the input restriction mode for each user. Alternatively, on/off of a restriction mode may be made settable for each user, and in a case where the restriction mode is set to on, the movement restriction mode or the input restriction mode may be settable. Alternatively, either the movement restriction mode or the input restriction mode may be set as a default setting. An administrator may collectively set these settings for all users. The virtual space management system 111 executes control for restriction of a movement of an avatar based on detection data of a user corresponding to an avatar (user avatar operation information corresponding to the detection of a user movement), based on either the movement restriction mode or the input restriction mode.

In order to prevent an arm of a user avatar of a user from slapping at a user avatar of a different user by an unexpected user movement, avatar-to-avatar restriction information for restricting actions by a user avatar of a user himself/herself on another avatar may be made registerable in the virtual space management system 111. Then, based on the avatar-to-avatar restriction information, the virtual space management system 111 executes control for restriction of a movement of an avatar based on detection data of a user that corresponds to the avatar.

As described above, according to each exemplary embodiment, it is possible to control a user avatar not to move or a part of a user avatar not to move when the movement is undesired by the user. In addition, it is possible to control a user avatar not to perform a movement unintended by the user.

In other words, it is possible to prevent a user avatar from performing a movement unintended by the user, which dramatically improves usability.

To obtain the effect of preventing a user avatar from performing a movement unintended by the user, the above-described exemplary embodiments may be applied to a system including a plurality of devices or to an apparatus including a single device. The above-described exemplary embodiments can be modified in various ways (including organic combinations of exemplary embodiments).

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-161726, filed Sep. 25, 2023, which is hereby incorporated by reference herein in its entirety.

What is claimed is:

1. A system including one or more computers, the system comprising:
one or more memories storing instructions; and
one or more processors capable of executing the instructions causing the system to:
execute control of a movement of an avatar in a virtual space,
wherein, as the control of the movement, restriction of a movement of an avatar based on detection data of a user corresponding to the avatar is executed according to either a movement restriction mode for restricting a movement of an avatar or an input restriction mode for restricting input from a user.

2. The system according to claim 1, wherein the instructions further cause the system to receive a first setting regarding a movement of an avatar that is to be restricted in the movement restriction mode.

3. The system according to claim 2,
wherein, in the first setting, a movement of an avatar that is to be restricted is set by designating a region in which movement of an avatar is to be restricted, and
wherein, as the control of the movement, a movement of a region of an avatar is restricted based on the first setting.

4. The system according to claim 2,
wherein, in the first setting, a movement of an avatar that is to be restricted is set by designating a movement shape of an avatar which is to be restricted, and
wherein, as the control of the movement, a movement of an avatar is restricted, based on the first setting such that the avatar is restricted from forming a shape matching or partially matching the designated movement shape of the avatar.

5. The system according to claim 1, wherein the instructions further cause the system to receive a second setting regarding input from a user that is to be restricted in the input restriction mode.

6. The system according to claim 5,
wherein, in the second setting, the input from the user that is to be restricted is set by designating a body region of a user from which input is to be restricted, and
wherein, as the control of the movement, a movement of an avatar that follows detection data of the designated body region of the user, in detection data of a user corresponding to an avatar, is restricted based on the second setting.

7. The system according to claim 5,
wherein, in the second setting, input from a user that is to be restricted is set by designating a shape of a user from which input is to be restricted, and
wherein, as the control of the movement, a movement of an avatar that follows detection data of a range matching or partially matching the designated shape of the user, in detection data of a user corresponding to an avatar, is restricted based on the second setting.

8. The system according to claim 7, wherein, in the second setting, the shape of the user from which input is to be restricted is designated using image capturing data obtained by capturing an image of the shape of the user from which input is to be restricted.

9. A control method for a system including one or more computers, the control method comprising:
executing control of a movement of an avatar in a virtual space,
wherein, as the control of the movement, restriction of a movement of an avatar based on detection data of a user corresponding to the avatar is executed according to either a movement restriction mode for restricting a movement of an avatar or an input restriction mode for restricting input from a user.
